(19) United States
(12) Patent Application Publication
(10) Pub. No.: US 2025/0191473 A1
(43) Pub. Date: Jun. 12, 2025

(54) VESSEL NAVIGATION BOUNDARY COLLISION AVOIDANCE METHOD

(71) Applicant: Ship and Ocean Industries R&D Center, New Taipei City (TW)

(72) Inventors: WEI-CHU WENG, Keelung City (TW); HAO-SHAN LI, New Taipei City (TW); CHI-MIN LIAO, New Taipei City (TW); CHUAN-FU LIN, New Taipei City (TW); HUNG-YUAN LU, New Taipei City (TW)

(21) Appl. No.: 18/542,557

(22) Filed: Dec. 15, 2023

(30) Foreign Application Priority Data
Dec. 8, 2023 (TW) 112147908

(51) Int. Cl. G08G 3/02

(52) U.S. Cl. CPC G08G 3/02

(57) ABSTRACT

The present invention provides a vessel navigation boundary collision avoidance method. Specifically, the vessel navigation boundary collision avoidance method first performs step (A) of providing at least one boundary. In step (B), a plurality of dummy ships are established along the at least one boundary, wherein the dummy ships are freezing and each of the dummy ships is connected to at least a part of another via an intersection point. In step (C), a dummy ship domain and a dummy obstacle domain are sequentially formed according to each of the dummy ships and each of the intersection points. In step (D), a dummy ship anti-collision circle and a dummy obstacle anti-collision circle are sequentially generated based on the dummy ship domain and the dummy obstacle domain if a sailing ship domain is to have a possibility of invading the dummy ship domain and the dummy obstacle domain.

### FIELD OF THE INVENTION

The present invention relates a vessel navigation boundary collision avoidance method and, more particularly, to a vessel navigation boundary collision avoidance method establishing a plurality of dummy ships by using identifiable boundaries in a restricted water domain to accordingly plan a collision avoidance navigation route.

### DESCRIPTION OF THE PRIOR ART

With the development of technologies, the International Maritime Organization (IMO) has classified levels and specifications of autonomous ships into various classes. An unmanned ship is defined to need an autonomous navigation system so as to guide the ship to arrive at a destination safely.

In algorithms of various autonomous navigation systems, the use of ship domains, a false destination method and safety circles have been practiced for years. However, the methods above are suitable only for avoiding collisions against other water vessels, and have to follow the Convention on the International Regulations for Preventing Collisions at Sea (COLREG).

For situations of water vessels entering harbors, entering river courses or berthing in ports involving terrestrial or building factors in a way that conditions in restricted water domains for a navigation route are affected, there is no reasonable solution for overcoming related issues.

More specifically, humans are able to determine how to navigate or berth a water vessel according to electronic nautical charts, paper nautical charts and a current location of the water vessel. However, for unmanned water vessels or various water vessels that automatically navigate by using computers, decision-making for navigation in a restricted water domain remains a challenge.

### SUMMARY OF THE INVENTION

To overcome the issues of the prior art described above, the present invention provides a vessel navigation boundary collision avoidance method.

Specifically, the vessel navigation boundary collision avoidance method first performs step (A) of providing at least one boundary. In step (B), a plurality of dummy ships are established along the at least one boundary, wherein the dummy ships are freezing and each of the dummy ships is connected to at least a part of another via an intersection point. In step (C), a dummy ship domain and a dummy obstacle domain are sequentially formed according to each of the dummy ships and each of the intersection points.

Lastly, in step (D), a dummy ship anti-collision circle and a dummy obstacle anti-collision circle are sequentially generated based on the dummy ship domain and the dummy obstacle domain if a sailing ship domain is to have a possibility of invading the dummy ship domain and the dummy obstacle domain.

The above summary of the present invention aims to provide a basic illustration for various aspects and technical features of the present invention. The summary of the present invention is not a comprehensive description of the present invention, and is not intended to specifically enumerate examples of key or critical elements of the present invention, nor is it intended to define the scope of the present invention, but is to present several concepts of the present invention in a simple form.

### BRIEF DESCRIPTION OF THE DRAWINGS

FIG. 1 is a flowchart of an operation method according to an embodiment of the present invention;

FIG. 2 is a schematic diagram of a nautical chart according to an embodiment of the present invention;

FIG. 3 is a schematic diagram of generating dummy ships and intersection points according to an embodiment of the present invention;

FIG. 4 is a schematic diagram of generating dummy ship domains and dummy obstacle domains according to an embodiment of the present invention;

FIG. 5 is a schematic diagram of generating a dummy ship anti-collision circle and a dummy obstacle anti-collision circle according to an embodiment of the present invention; and

FIG. 6 is a schematic diagram of generating a collision avoidance navigation route according to an embodiment of the present invention.

### DETAILED DESCRIPTION OF THE EMBODIMENTS

To better understand the technical features and practical effects of the present invention, implementation can be carried out according to the contents of the detailed description given by way of the preferred embodiments described in detail with reference to the accompanying drawings below.

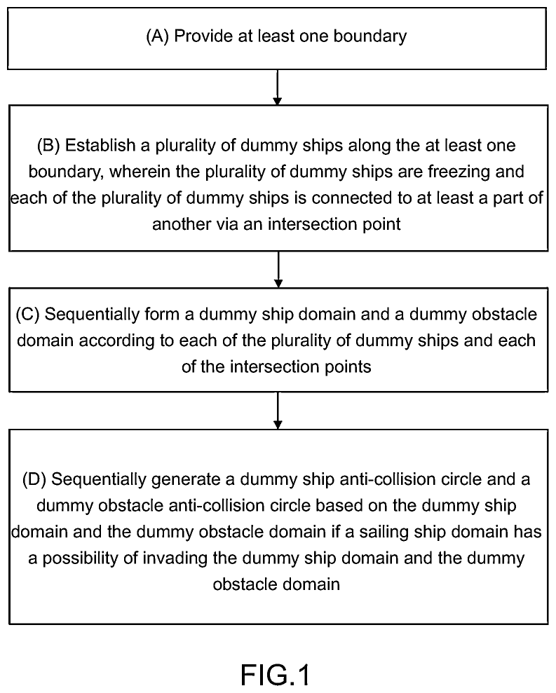

Referring to FIG. 1, FIG. 1 shows a flowchart of an operation method according to an embodiment of the present invention. In this embodiment, the vessel navigation boundary collision avoidance method first performs step (A) of providing at least one boundary. Next, in step (B), a plurality of dummy ships 101 are established along the at least one boundary B, wherein the dummy ships 101 are freezing and each of the dummy ships 101 is connected to at least a part of another via an intersection point 102. In step (C), a dummy ship domain 101a and a dummy obstacle domain 102a are sequentially formed according to each of the dummy ships 101 and each of the intersection points 102.

In step (D), a dummy ship anti-collision circle 103 and a dummy obstacle anti-collision circle 104 are sequentially generated based on the dummy ship domain 101a and the dummy obstacle domain 102a if a sailing ship domain V is to have a possibility of invading the dummy ship domain 101a and the dummy obstacle domain 102a.

The substantial steps of the embodiment of the present invention are described according to FIG. 1 above. Next, various implementation forms of this embodiment are described in the paragraphs below.

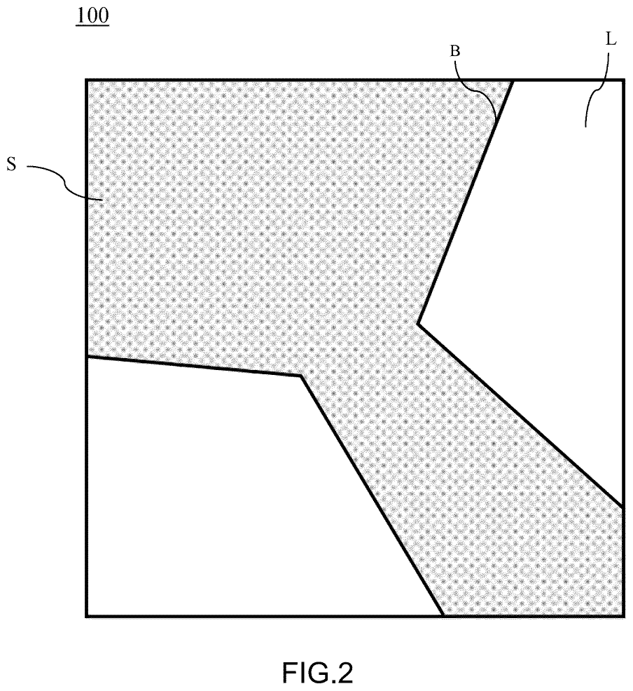

Referring to both FIG. 1 and FIG. 2, FIG. 2 shows a schematic diagram of a nautical chart according to an embodiment of the present invention. More specifically, the at least one boundary B provided in step (A) of this embodiment can be generated from an electronic nautical chart, a paper nautical chart or other image recognition files.

In this embodiment, a nautical chart 100 is an electronic nautical chart. A navigable region S in the nautical chart 100 is basically a water domain in which water vessels can be steered, and can include, for example but not limited to, rivers, lakes, seas and oceans. In this embodiment, the navigable region S can also be a river entrance or a port. Similarly, a non-navigable region L is defined, detected or man-specified as a region in which water vessels cannot be steered. The non-navigable region L can be land, docks, embankments, ecological reserves, aquaculture and fishery areas and other regions that are man-made or physically impossible to realize; such is not specifically defined by the present invention.

More specifically, a definition line defining between the non-navigable region L and the navigable region S is the boundary B. Thus, the boundary B is a shore boundary in a restricted water domain. In this embodiment, the generation of the boundary B can be man-made, or simply acquired from known map information generated according to detection performed by a sensor such as a lidar or a detection apparatus such as a radar, or be generated by identifying boundaries in aerial photos or satellite images of restricted water domains using artificial intelligence image recognition. It should be noted that the generation and the definition of the boundary B similarly are not specifically defined by the present invention.

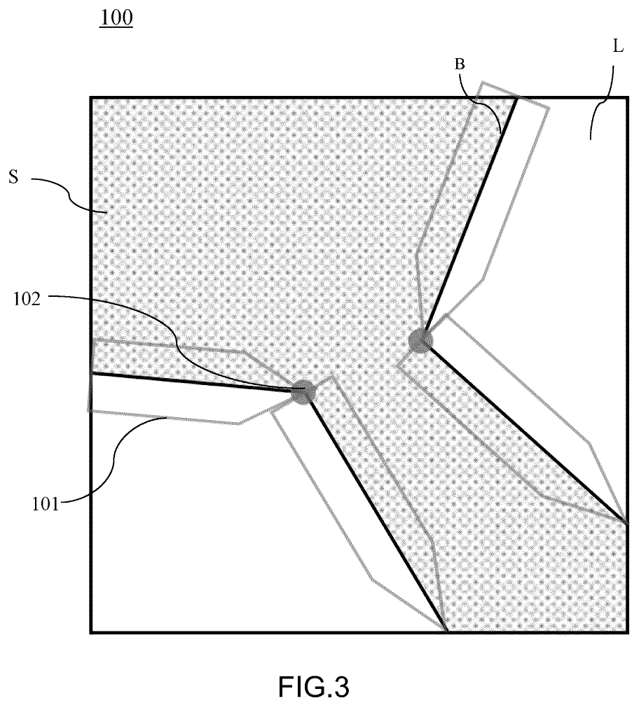

Referring to both FIG. 1 and FIG. 3, FIG. 3 shows a schematic diagram of generating dummy ships and intersection points according to an embodiment of the present invention. In step (B), the plurality of dummy ships 101 are simulated according to the linear boundary B generated in this embodiment. In this embodiment, the plurality of dummy ships 101 have characteristics that bows and sterns thereof are connected and the plurality of dummy ships 101 are in a freezing state.

It should be noted that, the freezing state used in this embodiment means that the speed of the ships is close to zero or substantially zero. Moreover, the plurality of dummy ships 101 are regarded as dummies and not physically existing water vessels in this embodiment, and so in this embodiment, each of the plurality of the dummy ships 101 overlaps and is connected (including tangent) to at least a part of another via one intersection point 102 as a boundary.

More specifically, each of the dummy ships 101 is generated along the boundary B in the nautical chart 100 in a direction of a connection line between the bow and the stern thereof. When the boundary B is turned, bent or curved such that a sufficient length cannot be provided to form the connection line between the bow and the stern, the intersection point 102 is generated to form a new dummy ship 101, until all boundaries B in the nautical chart 100 of the restricted water domain are simulated to be the dummy ships 101 and the intersection points 102. Moreover, when the boundary B is a continuous long straight line, a maximum generated length can also be set for the connection line between the bow and the stern of each dummy ship 101, so as to prevent the generation of an overly large dummy ship 101 that may affect a subsequent collision avoidance determination.

In addition, in a possible implementation form of the present invention, the nautical chart 100 of a restricted water domain that exceeds a certain size can be divided according to a fixed size, and then the plurality of dummy ships 101 are sequentially generated according to the boundary B of each of the nautical charts 100 after the dividing, thus achieving an object of limiting the size of each of the dummy ships 101; such is not specifically defined by the present invention.

It should be noted that, the appearances and the details for generating the sizes of the dummy ships 101 and the intersection points 102 provided in FIG. 3 of this embodiment are merely examples for illustration purposes. In practice, the dummy ships 101 and the intersection points 102 are not necessarily displayed, prompted or represented in any form in actual implementations. The presentation of the freezing dummy ships 101 and the intersection points 102 is merely applied for the use of generating the dummy ship domain 101a and the dummy obstacle domain 102a in the subsequent steps; such is not specifically defined by the present invention.

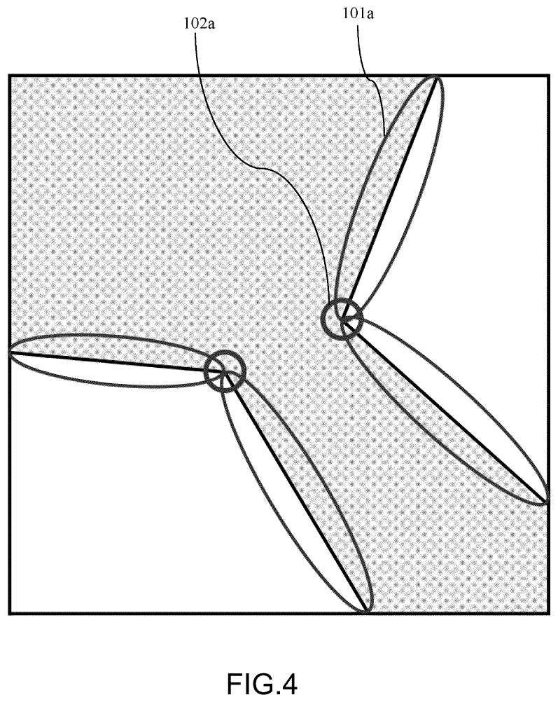

Referring to both FIG. 1 and FIG. 4, FIG. 4 shows a schematic diagram of generating dummy ship domains and dummy obstacle domains according to an embodiment of the present invention. As shown in FIG. 4, the details shown in FIG. 4 of this embodiment correspond to step (C) in FIG. 1. More specifically, after the plurality of dummy ships 101 and the intersection points 102 generated along the boundary B are determined, a ship domain of the plurality of dummy ships 101 can be generated according to a ship domain generation rule.

In this embodiment, the ship domain of each dummy ship 101 is generated by using an ellipse method, while the intersection points 102 are generated by using a circular method. Thus, the dummy ship domains 101a and the dummy obstacle domains 102a are sequentially generated based on the plurality of dummy ships 101 and the intersection points 102. The so-called dummy ship domain 101a in this embodiment is shaped as an ellipsoid, and the dummy obstacle domain 102a is shaped as a circle.

Whereas the dummy ships 101 and the intersection points 102 are not real physical ships or obstacles, details for generating the dummy ship domains 101a and the dummy obstacle domains 102a of this embodiment are as described below. First of all, a long-axis diameter of the ellipsoidal dummy ship domain 101a is defined as a length of the connection line between the bow and the stern of the corresponding dummy ship 101, and a short-axis radius of the dummy ship domain 101a is defined as a collision avoidance safety distance. In a preferred implementation form, the collision avoidance safety distance is generated using the ratio of the short axis to the long axis of the dummy ship domain 101a described above, which is between 2 and 100; such is not specifically defined by the present invention.

Furthermore, the dummy obstacle domain 102a is shaped as a circle, and a maximum radius of the dummy obstacle domain 102a is equal to the collision avoidance safety distance of the dummy ship domain 101a. As such, the boundary B can be preliminarily planned as the dummy ship domains 101a and the dummy obstacle domains 102a that can be technically used for collision avoidance.

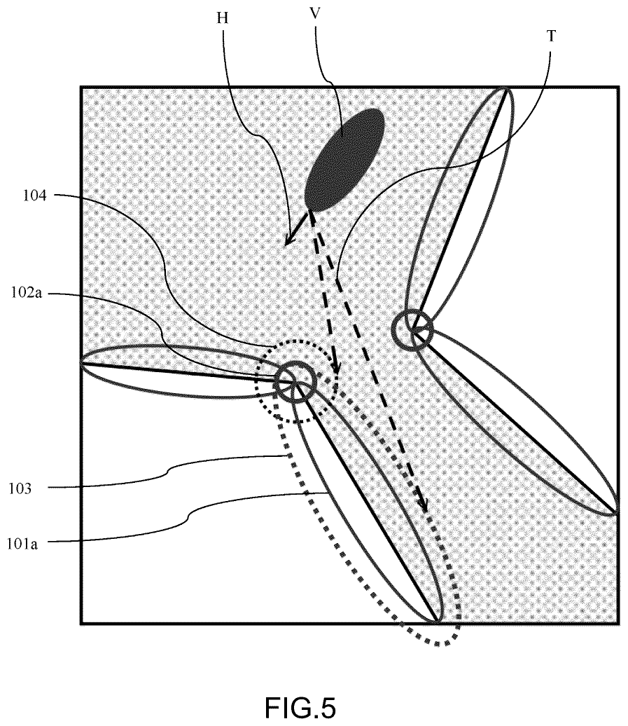

Referring to both FIG. 1 and FIG. 5, FIG. 5 shows a schematic diagram of generating a dummy ship anti-collision circle and a dummy obstacle anti-collision circle according to an embodiment of the present invention. In this embodiment, FIG. 5 illustrates a method for generating the dummy ship anti-collision circle 103 and the dummy obstacle anti-collision circle 104 in step (D) of FIG. 1. In this embodiment, step (D) needs to determine according to the sailing ship domain V in FIG. 5 whether to generate the dummy ship anti-collision circle 103 and the dummy obstacle anti-collision circle 104.

More specifically, the sailing ship domain V is generated by an autonomous ship that has to perform a collision avoidance decision-making. In this embodiment, the sailing ship domain V generated by an autonomous ship can be applied in addition to collision avoidance decision-making in actual navigation, or can be generated by an autonomous ship during simulation training of collision avoidance decision-making; such is not specifically defined by the present invention. In this embodiment, the sailing ship domain V generated by an autonomous ship is similarly shaped as an ellipsoid.

In this embodiment, in a sailing ship domain V while in course of sailing to a destination, if a ship generating the sailing ship domain V is not able to keep a safety distance from any one of the dummy ships 101 and the intersection points 102 and is thus determined to have a possibility of invading the dummy ship domains 101a, the dummy obstacle domains 102a generated in step (C) in FIG. 4 or a combination thereof, in order to enable the autonomous ship to be able to perform subsequent collision avoidance decision-making, the autonomous ship further generates the dummy ship anti-collision circle 103 and the dummy obstacle anti-collision circle 104 based on the dummy ship domains 101a and the dummy obstacle domains 102a according to the sailing ship domain V in which it sails.

In this embodiment, a range of the dummy ship anti-collision circle 103 shaped as an ellipsoid same as the sailing ship domain V has an ellipsoidal range (referring to the dotted ellipsoidal range in FIG. 5) formed by adding a short axis of the sailing ship domain V to the long-axis and short-axis parameters of the dummy ship domains 101a as a basis. The dummy obstacle anti-collision circle 104 is generated similarly, and differs in that, since the dummy obstacle domain 102a is shaped as a circle, the dummy obstacle anti-collision circle 104 generated has a circular range in a new radius (referring to the dotted circular range in FIG. 5) formed by adding a radius of the dummy obstacle domains 102a with the short axis of the sailing ship domain V.

Moreover, under navigation conditions in open water domains, the Convention on the International Regulations for Preventing Collisions at Sea (COLREG) need to be followed when two ships encounter each other and are about to collide with each other. However, the sources of the dummy ship anti-collision circle 103 and the dummy obstacle anti-collision circle 104 of this embodiment are the boundary B instead of real physical ships, and so collision avoidance routing planning can be performed without having to follow the Convention on the International Regulations for Preventing Collisions at Sea (COLREG).

Thus, as shown in FIG. 5, once both of the dummy ship anti-collision circle 103 and the dummy obstacle anti-collision circle 104 have been generated, the autonomous ship in the sailing ship domain V of this embodiment then performs collision avoidance routing planning according to related map information.

More specifically, an autonomous ship considers the possibility of colliding or invading the dummy ship domains 101a and the dummy obstacle domains 102a as the basis for whether to generate the dummy ship anti-collision circle 103 and the dummy obstacle anti-collision circle 104. After an element such as a sensor on the autonomous ship locates the geographical latitude and longitude position and determines a bow direction H of the autonomous ship, the autonomous ship first determines which of the dummy ship domains 101a and the dummy obstacle domains 102a it may encounter in course of navigating to its destination.

Meanwhile, the autonomous ship can neglect the dummy ship domains 101a and the dummy obstacle domains 102a with which it is impossible to encounter. Next, the dummy ship anti-collision circle 103 and the dummy obstacle anti-collision circle 104 are sequentially generated based on the dummy ship domains 101a and the dummy obstacle domains 102a that can possibly be encountered, and a collision avoidance navigation route P is planned in the bow direction H and in a tangent direction T closest to the dummy ship anti-collision circle 103 and the dummy obstacle anti-collision circle 104 that can possibly be encountered.

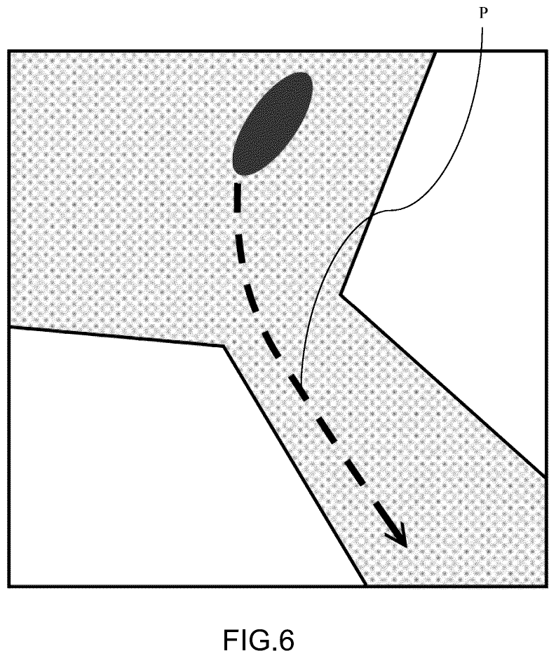

Referring to both FIG. 1 and FIG. 6, FIG. 6 shows a schematic diagram of generating a collision avoidance navigation route according to an embodiment of the present invention. As shown in FIG. 6, after performing the steps in FIG. 2 to FIG. 5 to accordingly implement the vessel navigation boundary collision avoidance method shown in FIG. 1, the navigation route P with the decision in the above step can be generated to complete collision avoidance planning.

The description above provides merely preferred embodiments of the present invention, and is not to be construed as limitations to the scope of implementation of the present invention. All simple and equivalent variations and modifications made based on the scope of claims and the detailed description of the present invention are encompassed within the scope of the present invention.

### EXPLANATION TO REFERENCE NUMBERS

100 nautical chart
101 dummy ship
102 intersection point
101a dummy ship domain
102a dummy obstacle domain
103 dummy ship anti-collision circle
104 dummy obstacle anti-collision circle
B boundary
S navigable region
L non-navigable region
V sailing ship domain
H bow direction
T tangent direction
P collision avoidance navigation route

What is claimed is:

1. A vessel navigation boundary collision avoidance method, comprising:
(A) providing at least one boundary;
(B) establishing a plurality of dummy ships along the at least one boundary, wherein the dummy ships are freezing and each of the dummy ships is connected to at least a part of another via an intersection point;
(C) sequentially forming a dummy ship domain and a dummy obstacle domain according to each of the dummy ships and each of the intersection points; and
(D) sequentially generating a dummy ship anti-collision circle and a dummy obstacle anti-collision circle based on the dummy ship domain and the dummy obstacle domain if a sailing ship domain is to have a possibility of invading the dummy ship domain and the dummy obstacle domain.

2. The vessel navigation boundary collision avoidance method according to claim 1, wherein the at least one boundary is a shore boundary.

3. The vessel navigation boundary collision avoidance method according to claim 1, wherein the sailing ship domain is generated by an autonomous ship.

4. The vessel navigation boundary collision avoidance method according to claim 1, wherein the dummy ship domain is shaped as an ellipsoid.

5. The vessel navigation boundary collision avoidance method according to claim 4, wherein a diameter of a long axis of the ellipsoid is a connection line between a bow and a stern of a corresponding one of the plurality of dummy ships, and a radius of a short axis of the ellipsoid is a collision avoidance safety distance.

6. The vessel navigation boundary collision avoidance method according to claim 5, wherein a ratio of the long axis to the short axis is between 2 and 100.

7. The vessel navigation boundary collision avoidance method according to claim 5, wherein the dummy obstacle domain is shaped as a circle.

8. The vessel navigation boundary collision avoidance method according to claim 7, wherein a radius of the circle is the collision avoidance safety distance.

9. The vessel navigation boundary collision avoidance method according to claim 1, wherein in step (D), it is first determined which of the dummy ship domains and the dummy obstacle domains that the sailing ship domain has a possibility to encounter in course of navigating to a destination, the dummy ship anti-collision circle and the dummy obstacle anti-collision circle are generated according to the dummy ship domains and the dummy obstacle domains, and a collision avoidance navigation route is planned according to a bow direction of the sailing ship domain and a tangent direction closest to the dummy ship anti-collision circle and the dummy obstacle anti-collision circle that are possibly encountered.

10. The vessel navigation boundary collision avoidance method according to claim 1, wherein in step (D), the dummy ship domains and the dummy obstacle domains that are impossibly encountered are neglected.
